(19) United States
(12) Patent Application Publication
(10) Pub. No.: US 2006/0278179 A1
(43) Pub. Date: Dec. 14, 2006

(54) Animal restraint

(76) Inventors: Miguel Antonio Vasquez, New South Wales (AU); Christopher Peter Franks, New South Wales (AU)

Correspondence Address: KING & SCHICKLI, PLLC, 247 NORTH BROADWAY, LEXINGTON, KY, 40507, US

(21) Appl. No.: 10/565,115

(22) PCT Filed: Jul. 14, 2004
(86) PCT No.: PCT/AU04/00942

§ 371 Date: May 12, 2006

(30) Foreign Application Priority Data
Jul. 17, 2003 (AU) 2003903657

(51) Int. Cl. A01K 27/00

(52) U.S. Cl. 119/864

(57) ABSTRACT

An animal restraint (10), typically as an animal collar, that encloses a girth of an animal including:—a belt (9) having a first (1) and second (2) belt ends and an elongate linker (3),—the first belt end (1) having an aperture (4),—the elongate linker (3) engaging the second belt end (2) at a first linker end, the elongate linker (3) passing through the aperture (4) to terminate at a stopper (7) at a second linker end; wherein a pulling force directed away from the girth of the animal applied to the stopper (7) when the restraint (10) is in a first larger girth position allows movement of, the elongate linker (3) through the aperture (4) throughout a plurality of second smaller girth positions to a minimum girth position, the minimum girth position being substantially similar to that of the girth of the animal.

### BACKGROUND OF THE INVENTION

The present invention relates to a restraint for an animal. More particularly, the present invention relates to a restraint with an adjusting peripheral extent.

### DESCRIPTION OF THE PRIOR ART

The reference to any prior art in this specification is not, and should not be taken as, an acknowledgment or any form of suggestion that the prior art forms part of the common general knowledge in Australia.

Training domestic animals is a common approach for encouraging the compliance of the animal with disciplinary commands from humans. Approaches for training animals often involve physically controlling the animal by way of, for the example of a dog, a restraint in the form of a collar, which is attached to a tether, which is usually in the form of a leash. Other animals with different anatomies, such as horses, require differently designed restraints, such as harnesses, which are tethered to a rope or leash.

Certain training regimes involve physical restraints which act not only to physically restrain the animal according to a trainer's or owner's requirements, but also constrict significantly around a portion of the animal's body when the animal does not obey an appropriate command. Examples of these types of restraints include “choker chains”. Simpler varieties of choker chains include those designed for use on dogs, and are formed from a leash portion (commonly a chain-link leash) integrally formed with a collar portion, the collar formed by way of the end of the leash looping back on itself through a ring-type aperture. The adjustable collar portion is loosened for placement about the dog's neck region, and can be adjusted for a comfortable fit about the dog's neck. However, when the dog does not respond according to a given command to stop or slow its movement, the collar portion tightens about the neck by a cinching effect as the leash moves through the ring. The extent of this choking effect is proportional to the animal's movements away from the direction of the leash of the chain (ie away from the trainer). The choking effect is painful to the dog, as the collar region assumes a size that is smaller than the dog's neck, causing pinching of the dog's skin and even constriction of the throat.

Modified forms of choker chain-type restraints include discrete choker collars, (collars not continuous with a leash region), which are of a variable extremity about the neck of an animal by virtue of a portion of the collar that acts to alter the peripheral extent of the collar. Typically, these length-altering portions are a chain-link region, which are attached to one end of a strap region of the collar, and pass through a ring on the opposite end of the collar and terminate in a leash-attaching member. A pulling force on this leash-attaching member has a cinching effect and tightens the collar, thus choking the dog in an identical manner to that described for choker chains.

The training concept underlying such devices is that this tightening provides a negative reinforcing effect such that the animal learns to associate the failure to respond with the painful sensation caused by the choking effect of the chain.

These simple, choker-type devices are viewed by many trainers, pet owners and animal activists as a cruel and inhumane mechanism for training an animal, as a consequence of the severe pain they can impart.

Alternative devices have been developed which employ the basic principle of these simple choker chains, but with various modifications, in an attempt to reduce the discomfort to the animal. These devices generally employ a tightening belt which is disposed about an animal's torso region, this region being more robust and less sensitive than the neck region. Nonetheless, these devices can still tighten excessively about the animal, assuming a size smaller than the animal's girth, and also pinching the skin and constricting the normal size of the torso. This is effectively choking the torso region of the animal. As such, these devices also cause significant discomfort and pain to the animal during training.

Such conventional training collars cannot be used in a non-training mode, that is, to simply walk the animal when training is not required. This is because of the cinching effect which occurs in normal use of the collar.

There is thus a need for animal restraints suitable for training an animal that may be used in both training and non-training modes, without causing significant discomfort by way of choking of the animal in either mode.

### SUMMARY OF THE PRESENT INVENTION

In its broadest form, the present invention provides a restraint for placement around a girth of an animal, the restraint including:
a belt having first and second belt ends, and an elongate linker,
the first belt end having an aperture; and
the elongate linker engaging the second belt end at a first linker end, the linker passing through the aperture to terminate at a stopper at a second linker end;
   wherein a pulling force directed away from the girth of the animal applied to the stopper when the restraint is in a first, larger girth position, allows movement of the elongate linker through the aperture throughout a plurality of second, smaller girth positions to a minimum girth position, the minimum girth position being substantially similar to that of the girth of the animal such that there is an absence of a choking of the animal's girth.

Preferably, the girth of the animal is a neck of an animal.

Preferably, the movement of the elongate linker through the aperture provides a noise detectable by the animal.

Even more preferably, the noise assists in the training of the animal.

In another preferred form, the elongate linker is a chain.

Preferably, the chain is a twist-link chain.

In yet another preferred form, the linker is formed from a linker material that optimises the noise detectable by the animal to achieve an optimal training response in the animal.

Preferably, the linker material is a chain having a gauge that is increased or decreased to optimise the noise detectable by the animal to achieve the optimal training response.

In yet another preferred form, the restraint further includes a placement device to facilitate location and/or adjustment of the restraint about the girth of the animal.

Preferably, the placement device is a buckle, the buckle having a buckle tongue, the strap including one or more holes for receiving the buckle tongue.

In another particularly preferred form, the restraint further includes a belt length-adjustment device and at least one of the belt ends, the belt being doubled at the belt end for passing through the belt length-adjustment device, thereby lengthening or shortening the girth of the restraint.

In a preferred form, the stopper of the restraint is suitable for engagement with a tether.

In another preferred form, the stopper of the restraint is permanently attached to a tether.

In yet a further preferred form, the aperture of the restraint is in the form of a ring, such as an O-ring or a D-ring.

In a particularly preferred form, the restraint further includes a second belt-end ring on the second belt end, the second belt-end ring for engaging the first end of the elongate portion of the linker. Preferably, the second belt-end ring is a D-ring or an O-ring.

Preferably, the stopper of the restraint is substantially annular.

### BRIEF DESCRIPTION OF THE DRAWINGS

By way of example only, an embodiment of the present invention will now be described more fully hereinafter with reference to the accompanying drawings, in which:—

FIG. 1 is a schematic view of a collar according to a preferred embodiment of the present invention in a first position;

FIG. 2 is a schematic view of the collar shown in FIG. 1, in a second, tightened position.

### DETAILED DESCRIPTION OF THE PREFERRED EMBODIMENTS

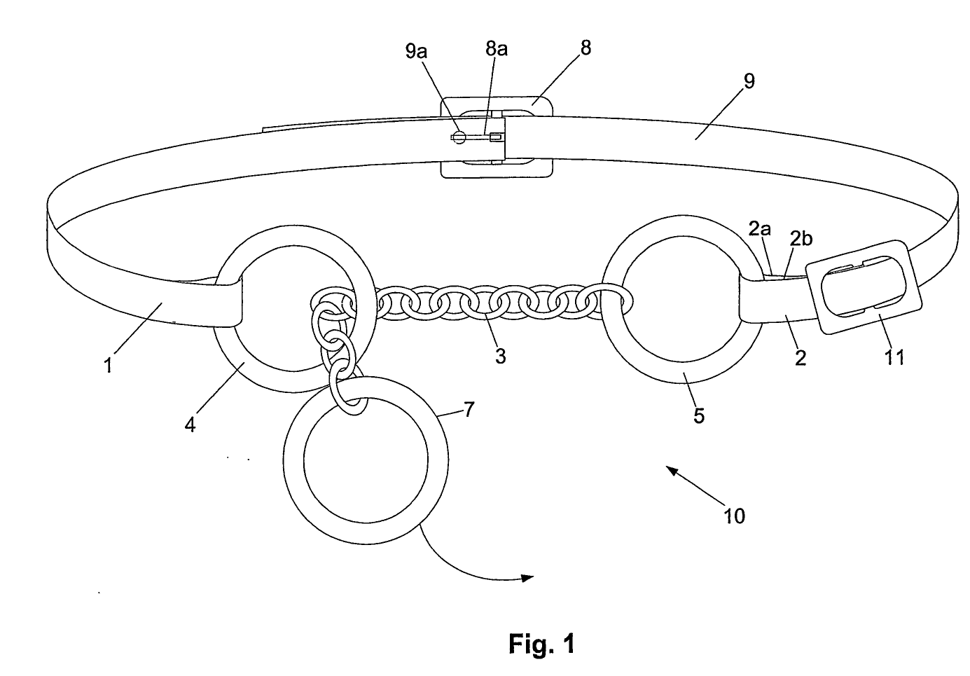

An example of a restraint according to the invention will now be described with reference to FIG. 1.

As shown, the restraint 10 generally includes a belt 9 with a first belt end 1, a second belt end 2, and an elongate linker, 3. In this embodiment, the belt ends 1, 2, are affixed to respective first and second belt-end rings, 4, 5. The linker 3, is in the form of a chain, such as a twist-link chain, and is attached to the second belt end 2 by the second belt-end ring 5, and passes through an aperture provided by the first belt-end ring 4. The restraint 10 also includes a placement device in the form of a buckle 8, the buckle having a buckle tongue 8a that is placed through a hole 9a in the belt 9, for ease of placement and/or adjustment of the restraint 10, around a girth of an animal. While the present embodiment shows the belt 9 having a buckle 8, it is to be understood that placement of the restraint 10 about the girth of the animal can be performed by peripheral adjustment by way of the linker only, and as such, a buckle is not a necessary feature. Furthermore, while the present example shows the belt 9 having just one hole 9a, it is to be understood that the belt 9 can have more than one hole.

In the presently exemplified embodiment, the belt 9 further includes a belt length-adjustment device 11, the belt 9 being looped through the second belt-end ring 5, so that the second belt end 2 comprises a double-sided region 2a, 2b. The second belt end 2 is threaded through the belt length-adjustment device 11, then fixed, for example by stitching or gluing, back on itself. The belt length-adjustment device 11 allows for adjustment of the girth of the belt 9, by feeding the belt that is adjacent to either side of the adjustment device 11 through the belt length-adjustment device 11, thereby lengthening or shortening of the double sided area 2a, 2b, of the second belt end 2. This allows the length of the belt 9 to be optimised for the specific girth of the particular animal, prior to the placement of the restraint 10 around the girth of the animal. For example, when the restraint is first purchased, the girth of the restraint can be optimised to the specific animal's girth, prior to placement of the device about the girth of the animal using for example, the buckle illustrated in the present example.

Although in the present embodiment the linker 3 is attached to the second belt end 2 by way of a second belt-end ring 5, it is to be understood that alternative arrangements for fixing the linker to the second belt end 2, such as via direct attachment, may be substituted for the presently exemplified embodiment.

While the elongate linker 3 of the present embodiment is exemplified as a chain, it is to be understood that alternative arrangements such as cables or ropes may be used, provided a noise which is detectable by the animal is created upon movement of the linker 3 through the first belt-end ring 4. Different animals vary in their responsiveness to auditory cues, and as such, the material forming the linker 3 can be chosen to optimise an animal's training response to the noise produced by movement of the linker 3, through the first belt-end ring 4. For example, where the linker material is a chain, a chain gauge (weight) can be varied to alter the noise produced.

In the current example, the elongate linker of the restraint is approximately 10 cm in length. However, it is to be clearly understood that there is no particular, fixed length for the length of the linker 3, as girths vary between animals and in relation to dogs, the girth of the neck varies considerably between different dog species. As such, the linker 3 can have a length between approximately 3 and 15 cm in length, wherein the exact length of the linker is chosen according to the requirements of the particular animal wearing the restraint.

In the present embodiment, the linker 3 terminates at a ring-shaped stopper 7, at an end of the linker 3 opposite the attachment to the second belt-end ring 5. Application of a force to the stopper 7, that is directed away from the girth of the animal, as indicated by the arrow in FIG. 1, pulls the linker 3 through the first belt-end ring 4 on the first belt end 1, thereby alternating the restraint 10 from a first, larger girth position between a plurality of second, smaller girth positions, to a minimum girth position, the minimum girth position being substantially similar to the girth of the animal about which the restraint 10 is placed.

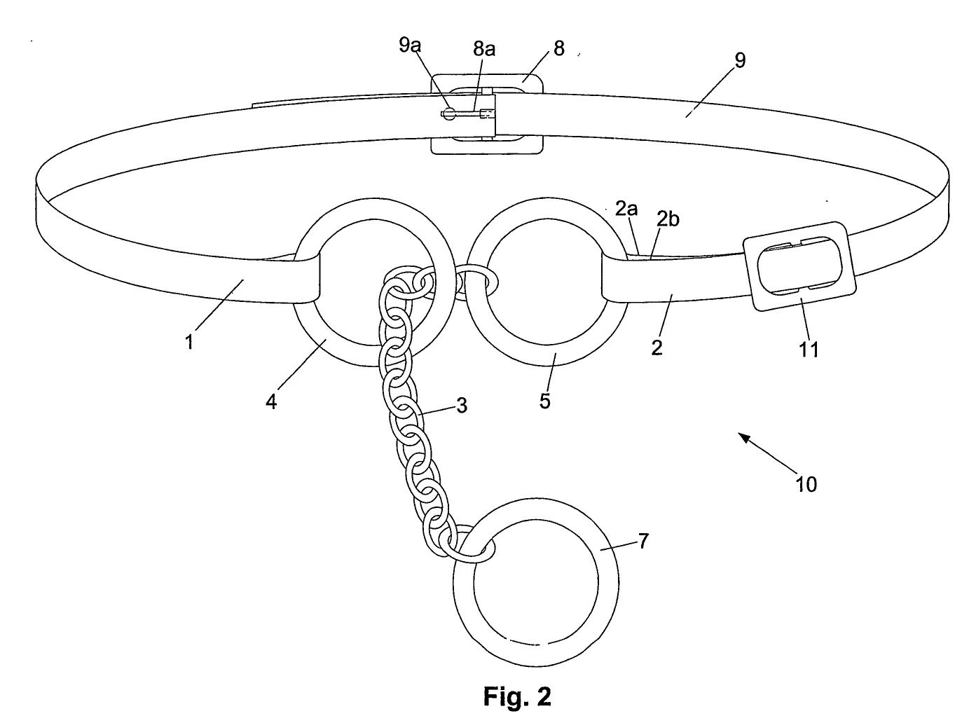

The minimum girth position is shown in FIG. 2, where the linker 3 has been substantially communicated through the first belt-end ring 4.

Movement of the linker 3 through the first belt-end ring 4 produces a sound that is detectable by the animal wearing the restraint 10.

Although the first belt-end ring 4 is presently exemplified as an annular member, it is to be understood that alternative arrangements for receiving the linker 3, and optionally assisting to produce the noise detectable by the animal upon movement of the linker chain 6, may also be used.

The stopper 7 is suitable for engaging a tether, such as a lead, leash or a rope, such that upon application of a pulling force to the tether, the force is transferred to the stopper 7, thereby effecting a reduction in the girth of the restraint 10. While the present embodiment shows a discreet restraint 10, as separate from an attachable tether, it is to be understood that the linker 3 can be permanently attached to a tether, such as by way of a permanently affixed chain-type tether.

In use, the restraint 10 is placed about the girth of the animal, such as a neck region of a dog. The fit of the restraint in the first, larger girth position, shown in FIG. 1, is slightly greater than the girth of the region about which the restraint is placed, preferably by an amount substantially the same as the elongate length of the linker 3. Upon application of the force to the stopper 7, the restraint 10 can assume one of the plurality of smaller girth positions or the minimum girth position, depending on the intensity and/or duration of the force. This alteration is achieved by virtue of the linker 3 moving through the first belt-end ring 4 following the application of the force.

The minimum girth position, which is shown in FIG. 2, is substantially the same as the girth of the animal about which the restraint is placed. As such, when the pulling force is applied to the stopper 7, the girth of the animal is not choked by way of excessive restriction as a consequence of the minimum girth position being determined by the length of the elongate linker 3. Preferably, the elongate linker 3 is three to fifteen centimetres in length.

As made clear by the present example, the design of the restraint 10 is such that there is no proportionally continuous tightening of the restraint 10 with the continued movement of the animal and/or a continued pulling force applied to the stopper 7, beyond a girth substantially similar to the girth of the animal about which the restraint 10 is placed. This feature thus prevents choking of the girth of the animal.

Preferably, after repeated use, an association is formed by the animal between the sound of the linker 3 moving through the first belt-end ring 4, and the animal's failure to comply with a command by a trainer or an owner. The animal thus perceives the sound as negative, and will modify its behaviour to prevent the sound from being initiated. Such ‘Pavlovian’-type, conditioned responses to an auditory cue may thus provide a behavioural change in the animal, which can be useful in training the animal. For example, if the animal is wearing the restraint 10 as a collar, and is walking on a leash at a pace which exceeds a pace set by an owner or trainer holding the leash, or if the animal fails to obey a ‘stop’ command, the sound of the linker 3 moving through the first belt-end ring 4, will be initiated. The trainer of the dog may provide verbal reprimands to the animal, which reinforce that the noise of the linker 3 moving through the first belt-end ring 4 is an indicator that the animal is not behaving in an appropriate manner, and that the sound is negative. As such, the animal may, for example, learn to slow a pace or cease movement altogether in response to a command, in order to prevent the sound of the linker 3 of the restraint 10 moving.

Unlike choker chains of the prior art, the non-choking feature of the restraint 10 allows for use of the restraint in a training mode and a non-training mode. That is, the restraint 10 can be worn by the animal when a trainer is enforcing certain verbal or visual commands, but if such a training session is not occurring (eg the animal is merely being exercised, without coincidental training), the restraint 10 can also be used during this non-training mode, as it will not choke the animal.

Persons skilled in the art will appreciate that numerous variations and modifications will become apparent. All such variations and modifications which become apparent to persons skilled in the art, should be considered to fall within the spirit and scope that the invention broadly appearing before described.

1-23. (canceled)

24. A restraint for placement around a girth of an animal, the restraint including:
a belt having first and second belt ends, and an elongate linker, the first belt end having an aperture; and
the elongate linker engaging the second belt end at a first linker end, the linker passing through the aperture to terminate at a stopper at a second linker end;
wherein a pulling force directed away from the girth of the animal applied to the stopper when the restraint is in a first, larger girth position, allows movement of the elongate linker through the aperture throughout a plurality of second, smaller girth positions to a minimum girth position, the minimum girth position being substantially similar to that of the girth of the animal such that there is an absence of a choking of the animal's girth.

25. The restraint according to claim 24, wherein the girth of the animal is a neck of an animal.

26. The restraint according to claim 24, wherein the movement of the elongate linker through the aperture provides a noise detectable by the animal.

27. The restraint according to claim 26, wherein the noise assists in the training of the animal.

28. The restraint according to claim 24, wherein the elongate linker is a chain.

29. The restraint according to claim 28, wherein the chain is a twist-link chain.

30. The restraint according to claim 24, wherein the elongate linker is formed from a linker material that optimizes a noise detectable by the animal to achieve an optimal training response in the animal.

31. The restraint according to claim 30, wherein the linker material is a chain having a gauge that is increased or decreased to optimize the noise detectable by the animal to achieve the optimal training response.

32. The restraint according to claim 24, wherein the restraint further includes a placement device to facilitate at least one of a location and adjustment of the restraint about the girth of the animal.

33. The restraint according to claim 32, wherein the placement device is a buckle having a buckle tongue, the belt including one or more holes for receiving the buckle tongue.

34. The restraint according to claim 32, further comprising a belt length-adjustment device, wherein at least one of the belt ends, the belt being doubled at the belt end for passing through the belt length-adjustment device, thereby lengthening or shortening the girth of the restraint.

35. The restraint according to claim 24, wherein the stopper of the restraint is suitable for engagement with a tether.

36. The restraint according to claim 24, wherein the stopper of the restraint is permanently attached to a tether.

37. The restraint according to claim 36, wherein the permanent attachment of the tether is by way of being continuous with the tether.

38. The restraint according to claim 24, wherein the aperture of the restraint is in the form of a ring.

39. The restraint according to claim 38, wherein the ring is an O-ring.

40. The restraint according to claim 38, wherein the ring is an D-ring.

41. The restraint according to claim 38 further comprising, a second belt-end ring on the second belt end, the second belt-end ring for engaging the first end of the elongate portion of the linker.

42. The restraint according to claim 41, wherein the second belt-end ring is a D-ring.

43. The restraint according to claim 41, wherein the second belt-end ring is an O-ring.

44. The restraint according to claim 24, wherein the stopper is substantially annular.

45. The restraint according to claim 24, wherein the belt is leather.

46. The restraint according to claim 24, wherein the belt is formed from webbed material.

47. A restraint for placement around a girth of an animal comprising:
a belt having first and second belt ends;
a ring attached to each of said first and second belt ends; and
a linker engaging said second belt end ring at a first linker end, passing through said first belt end ring, and terminating at a stopper at a second linker end;
wherein contact between said first and second belt end rings prevents the restraint from choking the animal's girth when a pulling force directed away from the girth of the animal is applied to said stopper.

48. A restraint for placement around a girth of an animal comprising:
a belt having first and second belt ends, the first and second ends directly attached to first and second belt rings;
a linker engaging the second belt end ring at a first linker end and passing through the first belt end ring; and
a stopper attached to a second linker end, said stopper contacting said first belt end ring in a first, larger girth position; and
wherein said first belt end ring contacting said second belt end ring in a second, minimum girt position when a pulling force directed away from the girth of the animal is applied to the stopper, the minimum girth position being substantially similar to that of the girth of the animal such that there is an absence of a choking of the animal's girth.
